(19) United States
(12) Patent Application Publication
(10) Pub. No.: US 2012/0246524 A1
(43) Pub. Date: Sep. 27, 2012

(54) DEBUGGING AID FOR SECURE WIRELESS SYSTEMS

(75) Inventors: Robert J. Thomas, Brier, WA (US); Patrick Gonia, Maplewood, MN (US)

(73) Assignee: HONEYWELL INTERNATIONAL INC., Morristown, NJ (US)

(21) Appl. No.: 13/072,348

(22) Filed: Mar. 25, 2011

(51) Int. Cl. G06F 11/08; G06F 11/07

(52) U.S. Cl. 714/49; 714/55; 714/E11.021; 714/E11.03

(57) ABSTRACT

In an encrypted wireless system, when a wireless node detects that it is having problems, it may be programmed to transmit one or more diagnostic messages without encryption, or with reduced encryption. The transmitted diagnostic messages may be received and interpreted by a technician troubleshooting the system. Once the technician troubleshoots and repairs the system, the affected wireless node may detect that it is operating normally, and may cease transmitting the unencrypted, or reduced-encryption, diagnostic messages. In most cases, the wireless system does not need any particular input to initiate the unencrypted, or reduced-encryption, diagnostic message transmissions.

### FIELD

The present disclosure relates generally to wireless systems, and more particularly, to debugging aids for secure wireless systems.

### BACKGROUND

When encryption is implemented in a wireless system, it is often difficult to diagnose and maintain the system when problems arise. For example, if a wireless node in an encrypted wireless system experiences a problem, it may be difficult to even detect that there is a problem. It may be even more difficult to diagnose the problem because transmissions from the affected node are encrypted.

### SUMMARY

The present disclosure relates generally to wireless systems, and more particularly, to debugging aids for secure wireless systems. In one illustrative embodiment, a wireless node of a secure wireless network includes a controller, a wireless transmitter, and a diagnostic module. The diagnostic module may be part of or separate from the controller, as desired. In some instances, the controller is configured to secure a data message using a first security key, and transmit the secure data message via the wireless transmitter to a neighboring wireless node in the wireless network.

The diagnostic module may detect a diagnostic condition in the corresponding wireless node. A diagnostic condition may be detected when a corresponding diagnostic metric goes beyond a predetermined threshold. In some instances, the diagnostic condition may indicate, for example, an error condition such as a communication error condition, a maintenance condition indicating maintenance is required or will be required, a sub-performance condition indicating that the wireless node is not operating at optimal performance, or any other diagnostic condition. In some cases, the particular diagnostic condition may be customizable for each wireless node, if desired

The diagnostic conditions may be detected in a wireless node by one or more self-checks initiated by the diagnostic module itself. If the diagnostic module detects one or more predefined diagnostic conditions, the controller of the corresponding wireless node may transmit a corresponding diagnostic message via the wireless transmitter of the wireless node. The diagnostic message may be unsecured, or may be secured using a second security key, where the second security key is different from the first security key.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION

The disclosure may be more completely understood in consideration of the following detailed description of various illustrative embodiments of the disclosure in connection with the accompanying drawings, in which:

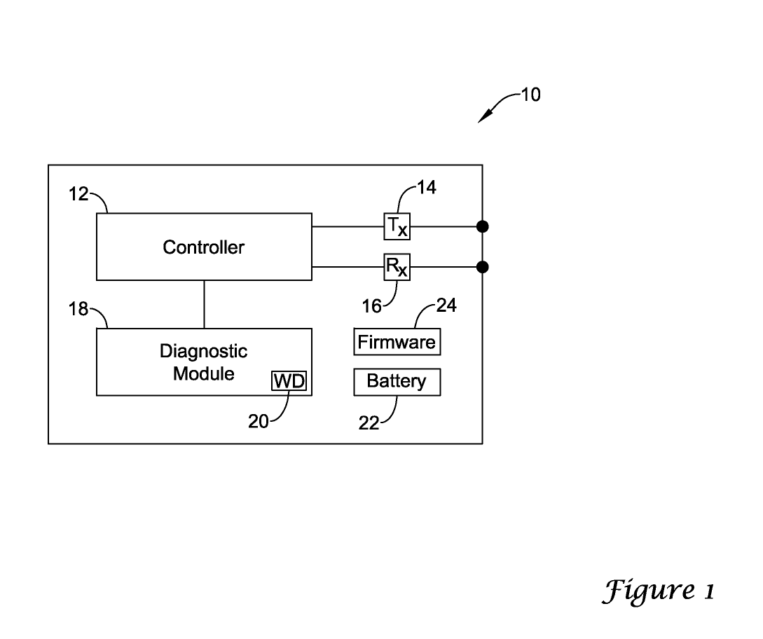

FIG. 1 is a schematic diagram of an illustrative wireless node;

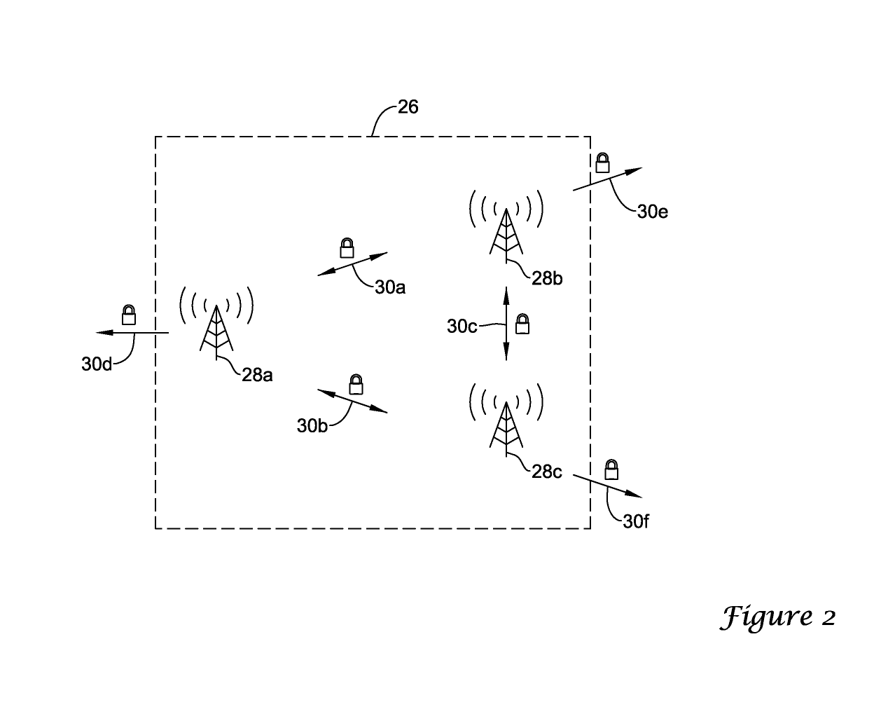

FIG. 2 is a schematic diagram of an illustrative wireless network;

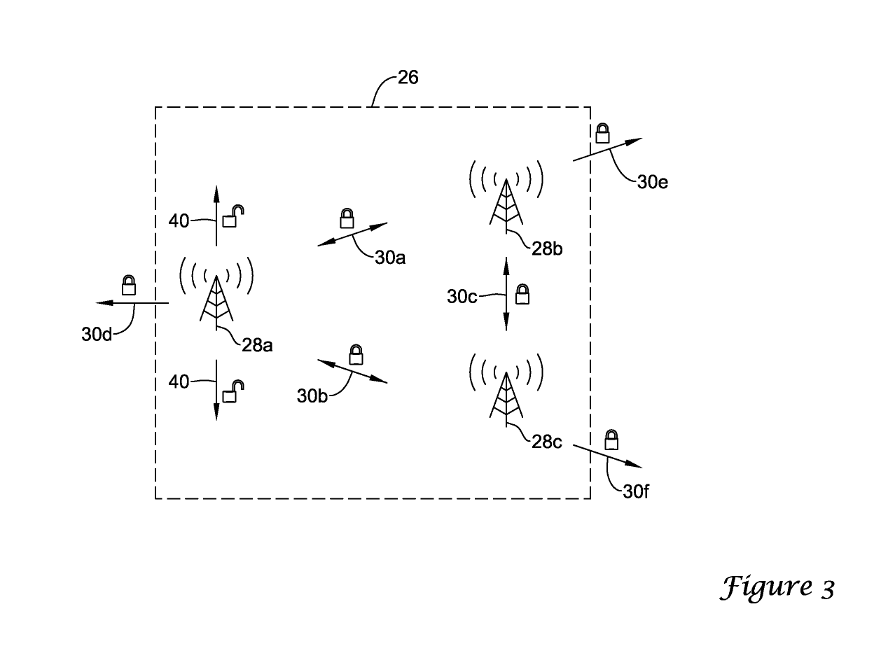

FIG. 3 of a schematic diagram of the illustrative wireless network of FIG. 2 with a wireless node transmitting both secure data messages as well as less secure or unencrypted diagnostic messages;

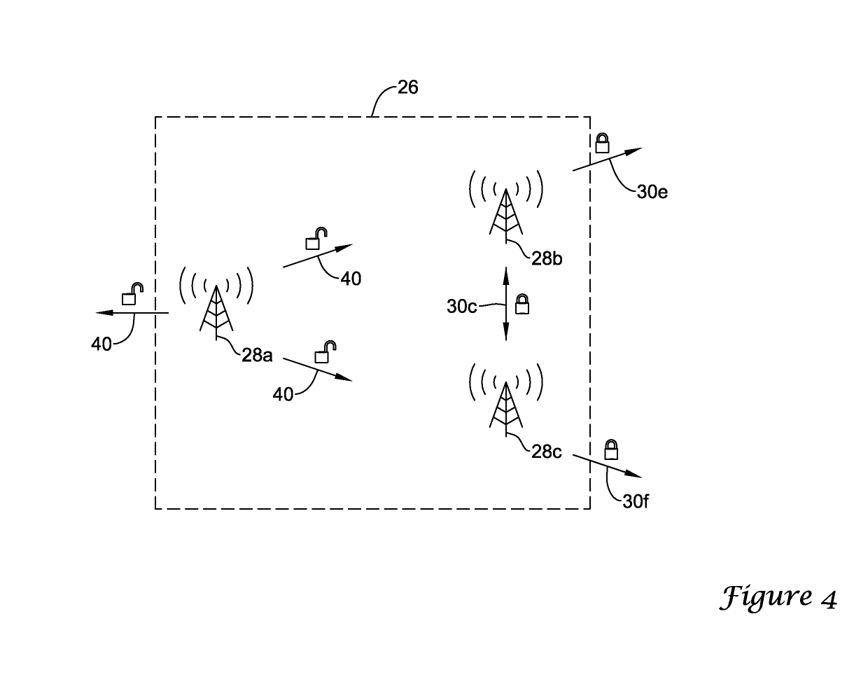

FIG. 4 of a schematic diagram of the illustrative wireless network of FIG. 2 with a wireless node transmitting less-secure or unencrypted diagnostic messages and not transmitting secure data messages; and

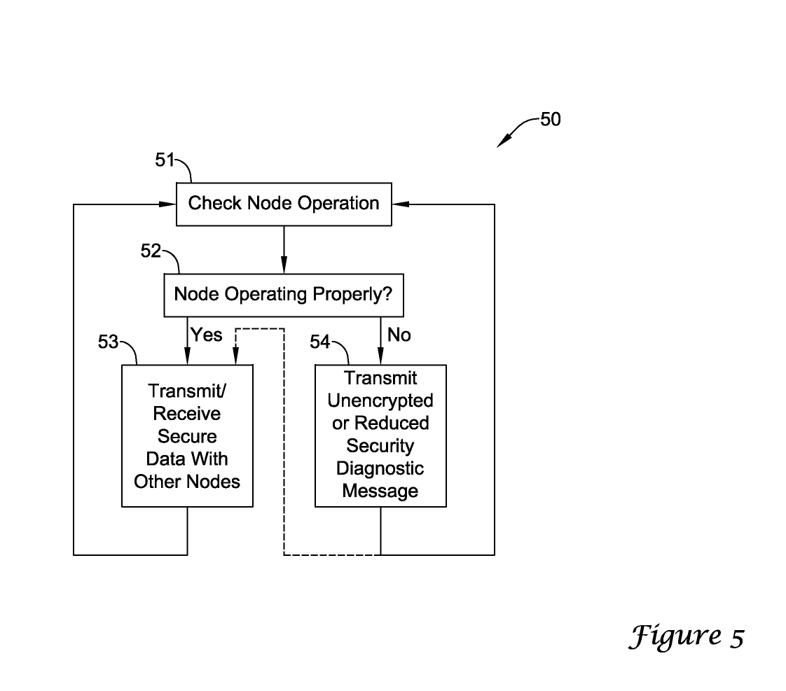

FIG. 5 is a flow diagram showing an illustrative method for operating a wireless node of a wireless network.

### DESCRIPTION

The following description should be read with reference to the drawings wherein like reference numerals indicate like elements throughout the several views. The detailed description and drawings show several embodiments which are meant to be illustrative of the disclosure.

Encryption typically protects the contents of a message from being understood by an attacker. Generally, it is also desirable to provide authentication so that a wireless message is verified to be from a source that is trusted. Authentication typically involves attaching a message integrity code (MIC) whose value is based on the message contents and the security key. Often, both encryption and the MIC, when provided, are based on the same security key. In many instances, both encryption and authentication are used in a secure wireless network.

Referring to FIG. 1, and in one illustrative embodiment, a wireless node 10 of a secure wireless network may include a controller 12, a wireless transmitter 14, a wireless receiver 16, and a diagnostic module 18. The wireless transmitter 14 and the wireless receiver 16 are used to transmit and receive messages, respectively. It is contemplated that diagnostic module 18 may be part of or separate from the controller 12, as desired. In some instances, the controller 12 is configured to secure a data message using a first security key, and transmit the secure data message via the wireless transmitter 14 to a neighboring wireless node in a wireless network. This may involve both encryption and authentication, as described above. The wireless receiver 16 may receive a secured data message, and the controller 12 may decrypt and authenticate the data message.

If one of the wireless nodes 10 in a wireless network experience a problem due to wireless issues, the affected wireless node 10 may be able to detect that it is experiencing problems, but in some cases, may not be able to resolve the problem. When a wireless node 10 detects that it is having problems, it may periodically transmit with reduced-security diagnostic messages that include information about the detected diagnostic condition. It is contemplated that the diagnostic messages may be received by a technician troubleshooting the system. Once the technician troubleshoots and repairs the system, the affected wireless node 10 may detect that it is operating normally, and may cease transmission of the reduced-security diagnostic messages. In some instances, the wireless node 10 does not need any particular input from a technician or other user to initiate the transmission of the unencrypted, or reduced-security, diagnostic messages. A potential advantage of using such the unencrypted, or reduced-security, transmissions from the affected node is that such transmissions may give a troubleshooter the ability to listen to signals from affected nodes in the system, and may therefore improve the troubleshooter's ability to diagnose problems with the wireless nodes in the system. The troubleshooter's ability to listen would be based on the possession of a common diagnostic key whereas the security key used for securing non-diagnostic messages may not be readily available.

The reduced-security messages referred to above may be encrypted with an encryption key. However, in some instances, the key for encrypting the reduced-security diagnostics messages may be a common key for all systems and thus less secure than a unique key for a particular system. Thus, the reason it may be considered less secure is that it is may be more likely that an attacker may be able to discover the diagnostic key since it may be common across many systems. In some instances, the reduced-security messages may not be encrypted at all.

In the illustrative embodiment of FIG. 1, the diagnostic module 18 may be programmed to detect a diagnostic condition in the corresponding wireless node 10. A diagnostic condition may be detected when, for example, a corresponding diagnostic metric goes beyond a predetermined threshold. In some instances, a diagnostic condition may indicate, for example, an error condition such as a communication error condition (e.g. parity errors, frame check errors, messages not authenticated or not recognized after decryption, lost or reduced signal strength, high packet retransmission counts, etc.), a maintenance condition indicating maintenance is required or will be required (e.g. low battery condition of a battery 22, a hardware error, etc.), a sub-performance condition indicating that the wireless node 10 is not operating at optimal performance (e.g. peer nodes are no longer responding, etc.), and/or any other diagnostic condition, depending on the application. In some cases, the particular diagnostic conditions that are associated with a particular wireless node 10 may be customizable, as desired, sometimes by reprogramming the firmware 24 (or other non-volatile memory) of the wireless node 10. Once reprogrammed, the firmware 24 may be read by the controller 12 and/or the diagnostic module 18, as desired.

In some cases, diagnostic conditions may be detected in the wireless node 10 by one or more self-checks initiated by the diagnostic module itself. If the diagnostic module 18 detects one or more predefined or pre-programmed diagnostic conditions (e.g. through one or more self-checks), the controller 12 may transmit a corresponding diagnostic message via the wireless transmitter 14 of the wireless node 10. The diagnostic messages may not be secured or may be secured using a second key, where the second key is different (e.g. more commonly available) than the primary key used to secure the data messages. In some cases, the diagnostic messages may include information about the detected diagnostic conditions to help a field technician diagnose and fix the problem.

In some instances, controller 12 of the wireless node 10 may transmit the diagnostic messages via the wireless transmitter 14 only when the diagnostic module 18 detects a diagnostic condition. The controller 12 may not transmit diagnostic messages via the wireless transmitter 14 if/when the diagnostic module 18 no longer detects a diagnostic condition. In some cases, the diagnostic messages may be transmitted periodically until the corresponding diagnostic conditions are resolved.

In some cases, the diagnostic module 18 may include a watchdog timer 20. The watchdog timer 20 may be used to detect, for example, hardware or software errors. For example, in some cases, the controller 12 may toggle an output (not explicitly shown) during normal operation of the controller 12. The toggled output may periodically reset the watchdog timer 20 to zero. If the controller 12 were to stop functioning properly (due to either a hardware or software error), the controller 12 might fail to toggle the output at the expected rate. When this occurs, the watchdog timer 20 may not be reset, and the watchdog timer 20 may reach a threshold time, causing the watchdog timer 20 to fire and, as a result to reset the controller. In some cases, if the watchdog timer 20 fires more than a threshold number of times, the diagnostic module 18 may detect a corresponding diagnostic condition. In this example, a watchdog timer metric that may be monitored by the diagnostic module 18 may be the number of times the watchdog timer 20 has fired.

In some instances, the diagnostic module 18 may monitor a link quality metric, which may indicate the link quality (e.g. 0 to 100%) between the wireless node 10 and one or more of its neighbors. The link quality can be affected over time by any number of factors. For example, and in some instances, the link quality may be affected when a wall is constructed between the wireless node 10 and its neighbor, or when a piece of furniture or other piece of equipment is moved in-between the wireless node 10 and its neighbor. Also, link quality may be affected by reduced performance of the wireless transmitter 14 or the wireless receiver 16 in either node or by electrical interference from another source. These are just some examples. When so provided, and in one example, the diagnostic module 18 may detect a diagnostic condition when a link quality metric falls below a link quality threshold.

In some cases, the diagnostic module 18 may monitor which and/or how many neighboring wireless nodes are in communication with the wireless node 10. The diagnostic module 18 may detect a diagnostic condition when the number of neighboring wireless nodes that are in communication with the wireless node 10 falls below a threshold number of nodes.

In some cases, the diagnostic module 18 may monitor a communication error metric. The communication error metric may include parity errors, frame check errors, messages not authenticated or not recognized after decryption, lost or reduced signal strength, high packet retransmission counts, etc.), and/or any other suitable communication error metric, as desired. When so provided, the diagnostic module 18 may detect a diagnostic condition when the communication error metric rises above a communication error threshold.

When the wireless node 10 is powered by a battery 22, the diagnostic module 18 may monitor a remaining battery level metric. When so provided, the diagnostic module 18 may detect a diagnostic condition if/when the remaining battery level metric falls below a battery level threshold.

In some cases, the diagnostic module can detect two or more diagnostic conditions of the wireless node 10, and may transmit a diagnostic message for each of the diagnostic conditions.

An illustrative method for operating the wireless node 10 in a wireless network may include securing a data message using a first encryption key, and transmitting the secured data message. Self-checks may be performed by the wireless node 10 to detect a diagnostic condition in the operation of the wireless node 10. If the self-checks detect a diagnostic condition, a diagnostic message may be transmitted that includes information about the detected diagnostic condition. In some cases, the diagnostic message may be transmitted only if the self-checks detect a diagnostic condition.

The diagnostic message may have reduced security or no security relative to the data message. In some cases, the diagnostic message may be secured using a second key, wherein the second encryption key is different from the first key used for the data message. In some instances, the second (diagnostic) key may be used by each of the two or more wireless nodes in many wireless networks to secure the corresponding diagnostic messages.

In some cases, the wireless node 10 may attempt to repair its own diagnostic conditions while transmitting the diagnostic messages. In some cases, the wireless node 10 may continue to transmit and/or receive data messages after a diagnostic condition is detected by the diagnostic module 18, and while diagnostic messages are also being transmitted. However, this may depend on the type of diagnostic condition detected. For example, the wireless node 10 may continue to transmit and/or receive data messages after a diagnostic condition is detected when the diagnostic condition is a low battery condition. However, the wireless node 10 may not continue to transmit and/or receive data messages after a diagnostic condition is detected when the diagnostic condition is related to a severe communication error. In other cases, the wireless node 10 may switch out of a normal operating mode and into an error mode when a diagnostic condition is detected, and cease transmitting and/or receiving data messages until the diagnostic condition is resolved. While in the error mode, the wireless node 10 may periodically send diagnostic messages that are secured with the diagnostic key.

In some cases, the transmission and/or retransmission of diagnostic messages may be relatively frequent, particularly when the wireless node 10 is powered by an AC line voltage or by an external AC or DC power supply. In other cases, the transmissions of diagnostic messages may be less frequent, particularly when the wireless node 10 is powered by a battery or batteries.

FIG. 2 is a schematic diagram of an illustrative wireless network 26 in normal operation. The illustrative wireless network 26 includes several wireless nodes, three of which are shown in FIG. 2 as 28a, 28b and 28c. During normal operation, the wireless nodes 28a-28c may transmit and receive secured data with other wireless nodes 28a-28c in the network 26, which may be referred to as “neighbor” wireless nodes with respect to a given wireless node. For instance, wireless node 28a may transmit and receive secured data messages 30a with neighbor wireless node 28b, and transmit and receive secured data messages 30b with neighbor wireless node 28c. The lock icon with the closed clasp indicated that transmission path is secured. A lock icon with an open clasp (see FIG. 3) indicated that the transmission path is unsecured (or secured using the diagnostic key).

In the example wireless network shown in FIG. 2, wireless node 28a has neighbor nodes 28b and 28c. In this example, wireless nodes 28b and 28c may transmit and receive secured data messages 30c with each other so that wireless node 28b has neighbor nodes 28a and 28c, and wireless node 28c has neighbor nodes 28a and 28b. In general, if the wireless network 26 includes a plurality of nodes 28a-28c, but not all the nodes 28a-28c can transmit and receive data directly with all the other wireless nodes, the neighbor wireless nodes are considered to be the wireless nodes with which a particular wireless node transmits and receives data directly. While this is one possible network topology, it is contemplated that any suitable network topology may be used, as desired.

Note that during normal operation, and in the example shown, wireless nodes 28a, 28b and 28c may also transmit secured data messages 30d, 30e and 30f out of the wireless network 26. In general, the encryption of the data messages 30d, 30e and 30f may make it more difficult, if not nearly impossible, for a passer-by to intercept and comprehend the secured data messages. Such a passer-by may be able to tell that data is being transmitted, but generally may not be able to decipher the transmitted data messages because of the encryption and/or authentication.

FIG. 3 is a schematic diagram of the illustrative wireless network of FIG. 2 with one of the wireless nodes 28a transmitting both secured data messages 30a, 30b and reduced security or un-secured diagnostic messages 40. In FIG. 3, the diagnostic module 18 of wireless node 28a has already detected a diagnostic condition as described above, and in response, is transmitting corresponding reduced security or un-secured diagnostic messages 40. In some cases, the wireless node 28a may attempt to repair its own diagnostic conditions while transmitting the diagnostic messages 40. The wireless node 28a may continue to transmit and/or receive secured data messages 30a, 30b while diagnostic messages 40 are also being transmitted. This, however, may depend on the type of diagnostic condition detected. For example, the wireless node 28a may continue to transmit and/or receive secured data messages 30a, 30b after a diagnostic condition is detected when the diagnostic condition is a low battery condition. However, the wireless node 28a may choose not to continue to transmit and/or receive secured data messages 30a, 30b after a diagnostic condition is detected when the diagnostic condition is related to a severe communication error (e.g. no detected link with wireless nodes 28b and 28c).

In other cases, the wireless node 10 may switch out of a normal operating mode into an error mode when a diagnostic condition is detected, and cease transmitting and/or receiving data messages until the diagnostic condition is resolved, as best shown in FIG. 4.

In some cases, the wireless node 28a may begin transmitting the diagnostic messages 40 as soon as it detects one or more diagnostic conditions. In other cases, the wireless node 28a may wait for a predetermined length of time before beginning the diagnostic message 40 transmission. In some cases, the diagnostic messages 40 include current information about the status of the wireless node 28a and/or information about the corresponding diagnostic condition. Such current information may be generated by the wireless node itself from self-diagnostics. In some cases, the wireless node 28a may attempt to repair itself while in the error mode. If the wireless node 28a determines that its self-repair is successful, the wireless node 28a may exit the error mode and return to the normal operation mode.

In some cases, the diagnostic messages 40 may be transmitted without any security. In other cases, the diagnostic messages 40 may be transmitted with a reduced security, at least compared to secured data messages 30a-30c, where a troubleshooting technician is given the diagnostic message security key for the diagnostic messages 40. In some cases, a diagnostic message security key may be made common to all the wireless nodes 28a-28c in the wireless network 26. In some cases, the diagnostic message security key may be made common to several wireless systems, such as when the wireless systems have a common owner or operator. Such a common diagnostic message security key may simplify the servicing of the wireless networks by a technician, who may only need a single diagnostic message security key to receive and diagnose any diagnostic message 40 that may arise from any of the wireless nodes 20a-20c in the wireless network 26 (or other wireless networks that may have the same diagnostic message security key).

There are many diagnostic conditions that may result in the transmission of a diagnostic message 40. Some illustrative diagnostic conditions may include, for example, a watchdog timer of the node firing more than a threshold number of times, failure to detect any neighbor nodes, a frame check sequence failure above a threshold ratio for packets received from a neighbor node, deterioration of the output of a battery that powers the wireless node, and/or any other suitable diagnostic condition. The wireless node 28a may use any or all of these, or other conditions, to identify a diagnostic condition.

In some instances, a diagnostic tool may engage in a two way dialog with the controller 12 and/or diagnostic module 18, particularly when a diagnostic condition exists. For example, it is contemplated that a wireless node 28a may not only send diagnostic messages 40, but may allow a diagnostic tool to query the wireless node 28a, and the wireless node 28a may respond by producing more or different diagnostic data. In some instances, this dialog may use a diagnostic security key. It is also contemplated that a diagnostic tool may have the ability to request that the wireless node 28a start sending diagnostic data. This request may also be secured using the diagnostic key.

FIG. 5 is a flow diagram showing an illustrative method 50 for operating a wireless node of a wireless network. In block 51, the wireless node 28a may check its operation. This may include performing one or more self-checks to detect a diagnostic condition in the operation of the wireless node 28a. In block 52, the wireless node 28a may decide from the self-checks if it is operating properly. If the self-checks do not detect a diagnostic condition, control may be passed to block 53. In block 53, the wireless node 28a may transmit and/or receive secured data messages with other nodes in the wireless network. However, if the self-checks detect a diagnostic condition, control may be passed to block 54. Block 54 may transmit less-secure or unencrypted diagnostic messages to a technician for trouble shooting purposes.

From block 54, in some instances, control may be passed to block 53, where the wireless node 28a may continue to transmit and/or receive secured data messages with other nodes in the wireless network. In other instances, control may be passed back to block 51, where the method is repeated.

Having thus described some illustrative embodiments of the present disclosure, those of skill in the art will readily appreciate that yet other embodiments may be made and used within the scope of the claims hereto attached. It will be understood that this disclosure is, in many respect, only illustrative. For example, while the disclosure is discussed primarily with respect to a wireless node and a wireless network, the disclosure can be equally applied to wired systems, or combination wired and wireless systems, as desired.

What is claimed is:

1. A wireless node for use in a secure wireless network, comprising:
a controller;
a wireless transmitter coupled to the controller;
the controller configured to secure a data message using a first security key, and transmitting the secure data message via the wireless transmitter;
a diagnostic module for detecting a diagnostic condition of the wireless node, wherein the diagnostic condition is detected when a corresponding diagnostic metric is beyond a predetermined threshold; and
the controller transmitting a diagnostic message via the wireless transmitter if the diagnostic module detects the diagnostic condition.

2. The wireless node of claim 1, wherein the controller encrypts the diagnostic message with a second security key, and transmits the corresponding diagnostic message via the wireless transmitter, wherein the second security key is different from the first security key.

3. The wireless node of claim 1, wherein the controller transmits the corresponding diagnostic message via the wireless transmitter without first encrypting the diagnostic message.

4. The wireless node of claim 1, wherein the controller no longer transmits the diagnostic message via the wireless transmitter when the diagnostic module no longer detects the diagnostic condition.

5. The wireless node of claim 1, wherein the diagnostic metric includes a link quality metric, and wherein the diagnostic module detects the diagnostic condition when the link quality metric falls below a link quality threshold.

6. The wireless node of claim 1, wherein the diagnostic module includes a watchdog timer coupled to and monitoring the controller, and the diagnostic metric includes a watchdog timer metric, wherein the diagnostic module detects the diagnostic condition when the watchdog timer metric is beyond a watchdog timer threshold.

7. The wireless node of claim 1, wherein the diagnostic metric includes a number of neighboring wireless nodes that are in communication with the wireless node, and wherein the diagnostic module detects the diagnostic condition when the number of neighboring wireless nodes that are in communication with the wireless node falls below a threshold number of nodes.

8. The wireless node of claim 1, wherein the diagnostic metric includes a communication error metric, and wherein the diagnostic module detects the diagnostic condition when the communication error metric rises above a communication error threshold.

9. The wireless node of claim 1, wherein the diagnostic metric includes a battery level metric, and wherein the diagnostic module detects the diagnostic condition when the battery level metric falls below a battery level threshold.

10. The wireless node of claim 1, wherein the diagnostic module can detect two or more diagnostic conditions of the wireless node, and wherein the diagnostic message corresponds to particular diagnostic condition detected by the diagnostic module.

11. A method for operating a wireless node in a wireless network, comprising:
encrypting a data message using a first security key, and transmitting the secure data message;
performing self-checks to detect a diagnostic condition in the operation of the wireless node, the self-checks performed by the wireless node itself; and
if the self-checks detect a diagnostic condition, transmitting a diagnostic message that includes information about the detected diagnostic condition.

12. The method of claim 11, wherein the diagnostic message is unencrypted.

13. The method of claim 11, wherein the diagnostic message is encrypted using a second security key, wherein the second security key is used more widely than the first security key.

14. The method of claim 13, wherein the wireless network includes two or more wireless nodes, and wherein the second security key is used by each of the two or more wireless nodes to encrypt corresponding diagnostic messages.

15. The method of claim 11, wherein the diagnostic message is transmitted only if the self-checks detect a diagnostic condition.

16. A wireless system, comprising:
a plurality of wireless nodes;
at least some of the wireless nodes of the plurality of wireless nodes being configured to transmit data to and receive data from at least one other neighbor node of the plurality of wireless nodes;
at least some of the wireless nodes of the plurality of wireless nodes having a normal operation mode in which the wireless node transmits secured data;
at least some of the wireless nodes of the plurality of wireless nodes configured to perform a number of self-checks to detect one or more diagnostic conditions in the operation of the wireless node, the self-checks performed by the wireless nodes themselves; and
if the self-checks detect one or more diagnostic conditions, the corresponding wireless node transmitting a diagnostic message that includes information about the detected diagnostic condition, wherein the diagnostic message has no encryption or is encrypted using a diagnostic security key that is different from a security key used to transmit the secure data in the normal operation mode.

17. The wireless system of claim 16, wherein if the wireless node is in the normal operation mode and if the number of self-checks detect a diagnostic condition in its operation, the wireless node exits the normal operation mode and enters a diagnostic mode.

18. The wireless system of claim 16, wherein the diagnostic condition in the operation of the wireless node includes at least one of:
a deterioration of link quality between the wireless node and a neighbor wireless node;
a watchdog timer of the wireless node firing more than a threshold number of times;
a failure to detect any neighbor wireless nodes;
at least one frame check sequence failure above a threshold ratio for packets received from a neighbor wireless node; or
a deterioration of the output of a battery that powers the wireless node.

19. The wireless system of claim 16, wherein the diagnostic conditions in the operation of the wireless nodes is customizable to each wireless node.

20. The wireless system of claim 16, wherein the diagnostic message is transmitted periodically from the wireless node.

21. The wireless system of claim 16, further comprising:
a diagnostic tool, wherein the diagnostic tool is configured to communicate with at least some of the wireless nodes in a two-way dialog to request that the at least some of the wireless nodes produce more of different diagnostic data.

22. The wireless system of claim 21, wherein the two-way dialog uses the diagnostic security key.

23. The wireless system of claim 21, wherein the diagnostic tool is configured to request at least some of the wireless nodes start sending diagnostic messages.
